(19) United States
(12) Patent Application Publication
(10) Pub. No.: US 2010/0201822 A1
(43) Pub. Date: Aug. 12, 2010

(54) INFORMATION PROCESSING APPARATUS

(75) Inventors: Kaoru ICHIMURA, Tokyo (JP); Daisuke Hidaka, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/647,716

(22) Filed: Dec. 28, 2009

(30) Foreign Application Priority Data
Feb. 12, 2009 (JP) 2009-029414

(51) Int. Cl. H04N 7/18

(52) U.S. Cl. 348/161; 348/E07.085

(57) ABSTRACT

An information processing apparatus includes: a detection mechanism that includes a transparent substrate on which a detection electrode pattern is provided in biaxial directions and detects, with one of main surface sides of the transparent substrate being an input operation surface, a position on the input operation surface within the biaxial space that an object has touched, the transparent substrate being capable of transmitting near-infrared light; a to-be-authenticated-object placement portion provided in the vicinity of the input operation surface and on which the object is placed as an object to be authenticated; a first light source to irradiate the near-infrared light onto the object to be authenticated; and a photographic camera that is provided on the other one of the main surface sides of the transparent substrate and photographs the object to be authenticated onto which the near-infrared light has been irradiated via the transparent substrate.

### BACKGROUND OF THE INVENTION

1. Field of the Invention

The present invention relates to an information processing apparatus including a biometric authentication apparatus and a touchpad.

2. Description of the Related Art

Various electronic apparatuses including an information processing apparatus such as a personal computer may be equipped with a biometric authentication apparatus that authenticates a finger as an object to be authenticated (see, for example, Japanese Patent Application Laid-open No. 2008-79798 (paragraph (0028), FIGS. 1 to 5) and Japanese Patent Application Laid-open No. 2008-83955 (paragraph (0030), FIGS. 1 to 5); hereinafter, referred to as Patent Documents 1 and 2).

In the electronic apparatuses disclosed in the specifications of Patent Documents 1 and 2, a touchpad as an input device and the biometric authentication apparatus are provided separately.

### SUMMARY OF THE INVENTION

However, since the input device and the biometric authentication apparatus are provided separately in the electronic apparatuses as described above, it has been difficult to miniaturize the entire electronic apparatuses.

In view of the circumstances as described above, there is a need for an information processing apparatus including a biometric authentication apparatus and an input device, that is capable of realizing miniaturization of the entire information processing apparatus.

According to an embodiment of the present invention, there is provided an information processing apparatus including: a detection mechanism that includes a transparent substrate on which a detection electrode pattern is provided in biaxial directions and detects, with one of main surface sides of the transparent substrate being an input operation surface, a position on the input operation surface within the biaxial space that an object has touched, the transparent substrate being capable of transmitting near-infrared light; a to-be-authenticated-object placement portion that is provided in the vicinity of the input operation surface of the detection mechanism and on which the object is placed as an object to be authenticated; a first light source to irradiate the near-infrared light onto the object to be authenticated placed on the to-be-authenticated-object placement portion; and a photographic camera that is provided on the other one of the main surface sides of the transparent substrate of the detection mechanism and photographs the object to be authenticated onto which the near-infrared light has been irradiated via the transparent substrate.

According to the embodiment of the present invention, by enabling the detection mechanism to transmit the near-infrared light, providing the photographic camera on the other main surface side of the detection mechanism, and further providing the first light source, a photographic apparatus and an input device can be integrated. With this structure, an installation area of those components can be made smaller than that in a case where the photographic apparatus and the input device are provided separately, and the entire information processing apparatus can thus be miniaturized.

In the embodiment of the present invention, the information processing apparatus further includes means for authenticating the object to be authenticated based on an image taken by the photographic camera. With this structure, the biometric authentication apparatus and the input device can be integrated. As a result, an installation area of those components can be made smaller than that in a case where the biometric authentication apparatus and the input device are provided separately, and the entire information processing apparatus can thus be miniaturized.

In the embodiment of the present invention, the information processing apparatus further includes a casing to hold the detection mechanism, the first light source, and the photographic camera. As described above, the detection mechanism, the first light source, and the photographic camera can be held by a single casing.

In the embodiment of the present invention, lighting of the first light source is started when an operation to the to-be-authenticated-object placement portion is detected. As described above, the to-be-authenticated-object placement portion can function as a switch for starting photographing or starting an authentication.

In the embodiment of the present invention, the information processing apparatus further includes a blindfold board that is provided adjacent to the detection mechanism between the detection mechanism and the photographic camera and transmits at least the near-infrared light. By thus providing the blindfold board, an internal structure of the casing cannot be seen by a user of the information processing apparatus, and a design is thus improved.

In the embodiment of the present invention, the information processing apparatus further includes a filter that is provided between the object to be authenticated and the photographic camera and transmits only the near-infrared light. With this structure, a vein pattern of the object to be authenticated can be photographed clearly.

In the embodiment of the present invention, the blindfold board includes a notched portion of a predetermined shape in an area other than an area corresponding to a photographic space between the photographic camera and the object to be authenticated, and the information processing apparatus further includes a second light source to irradiate light onto the notched portion. With this structure, the second light source can be lit during the photographing or authentication, with the result that the user of the information processing apparatus can recognize whether the object to be authenticated is being photographed or authenticated based on the lighting of the second light source.

In the embodiment of the present invention, lighting of the second light source is started when an operation to the to-be-authenticated-object placement portion is detected. Based on the lighting of the second light source, the user of the information processing apparatus can recognize whether the object to be authenticated is being photographed or authenticated.

In the embodiment of the present invention, the information processing apparatus further includes a near-infrared light window that is provided between the object to be authenticated and the first light source and transmits the near-infrared light. As a result, by the near-infrared light window, the first light source is accommodated without being exposed.

As described above, according to the embodiment of the present invention, an information processing apparatus that includes a photographic apparatus or a biometric authentication apparatus and an input device can be miniaturized.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a perspective view of a laptop PC (Personal Computer) according to an embodiment of the present invention in an opened state;

FIG. 2 is a perspective view of the PC shown in FIG. 1 in a state where a biometric authentication is carried out;

FIG. 3 is an exploded perspective view of a biometric-authentication-apparatus-attached touchpad incorporated into the PC shown in FIG. 1;

FIG. 4 is a cross-sectional diagram taken along the line A-A′ of FIG. 3;

FIG. 5 is an exploded perspective view of a transparent input sheet that constitutes a part of the biometric-authentication-apparatus-attached touchpad shown in FIG. 3;

FIG. 6 is a cross-sectional diagram taken along the line B-B′ of FIG. 5;

FIG. 7 are partially-enlarged diagrams of the biometric-authentication-apparatus-attached touchpad shown in FIG. 3 showing both states where a biometric authentication apparatus is unoperated and the biometric authentication apparatus is operated;

FIG. 8 is a plan view of the biometric-authentication-apparatus-attached touchpad during a biometric authentication by the biometric authentication apparatus;

FIG. 9 is a perspective view of a laptop PC according to another embodiment of the present invention in an opened state; and

FIG. 10 is an exploded perspective view of a biometric-authentication-apparatus-attached touchpad incorporated into the PC shown in FIG. 9.

### DESCRIPTION OF PREFERRED EMBODIMENTS

Hereinafter, embodiments of the present invention win be described with reference to the drawings.

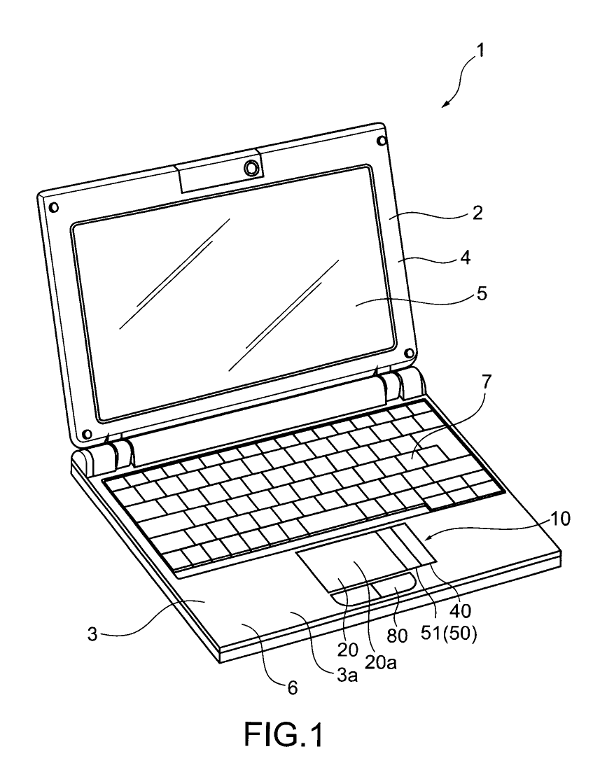

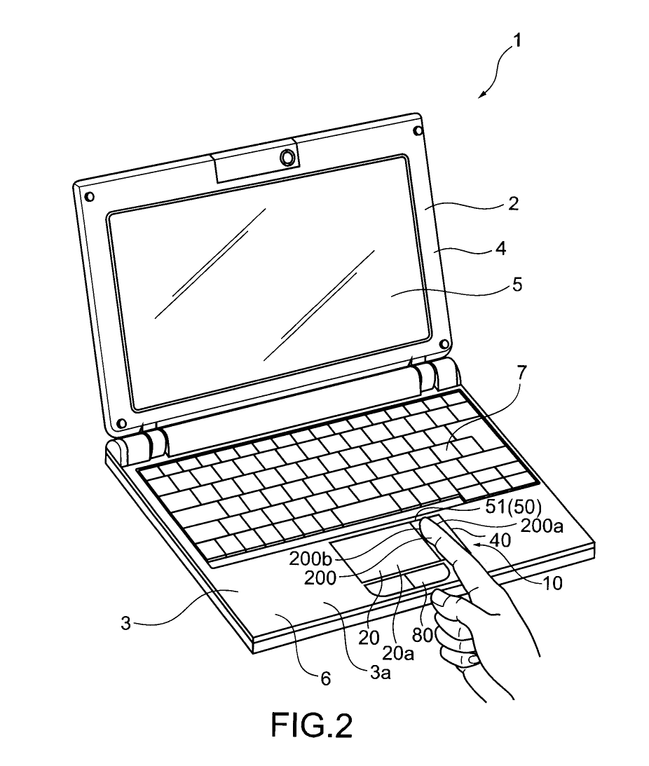

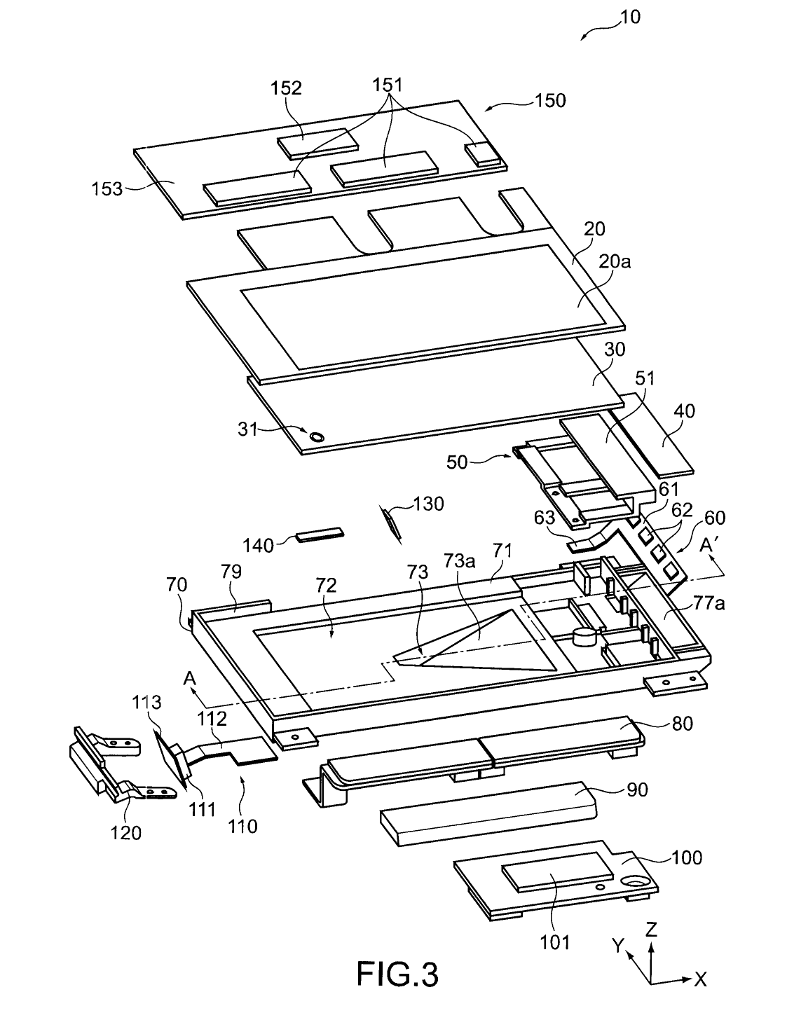

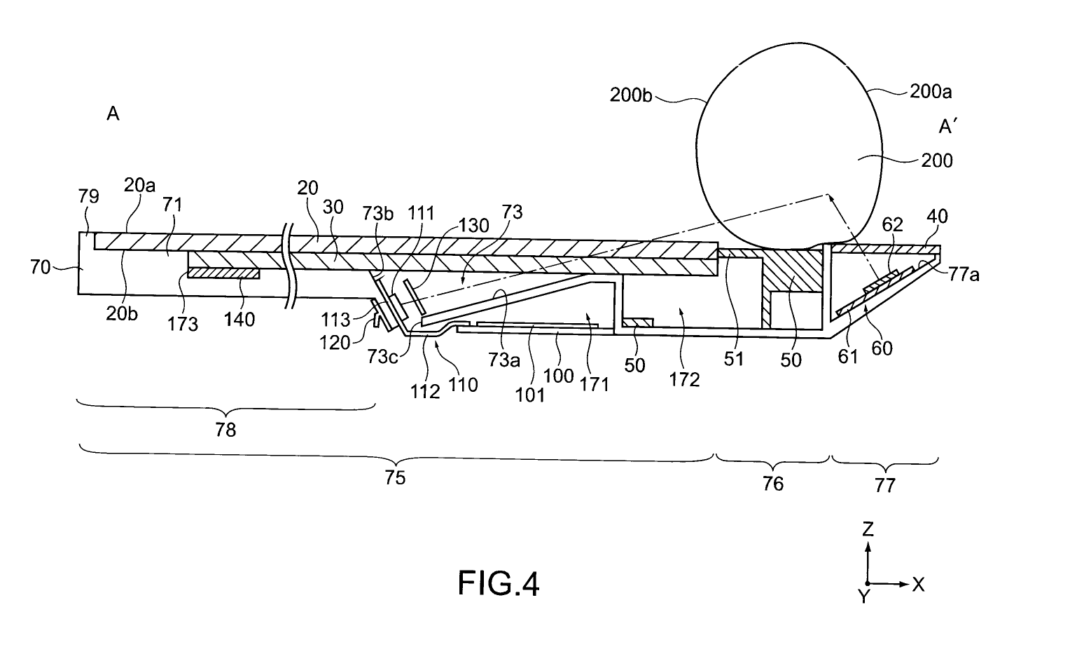

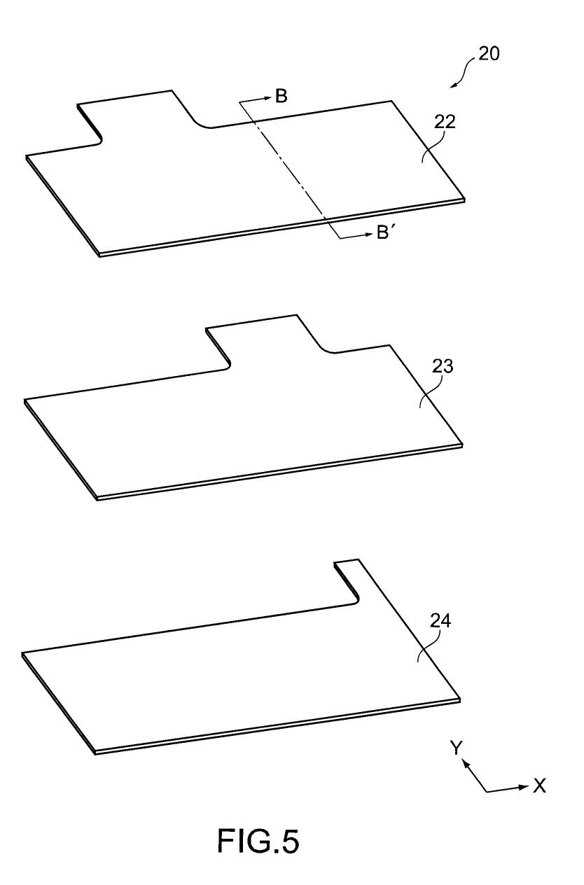

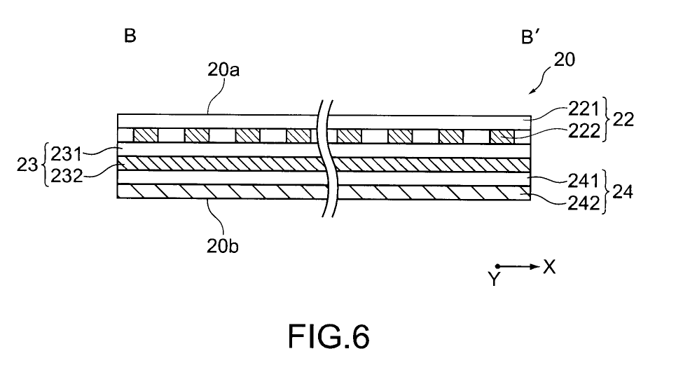

FIG. 1 is a perspective view of a laptop PC (Personal Computer) as an information processing apparatus according to an embodiment of the present invention in an opened state. FIG. 2 is a perspective view of the PC shown in FIG. 1 in a state where a finger as an object to be authenticated is placed on a biometric-authentication-apparatus-attached touchpad for a biometric authentication. FIG. 3 is an exploded perspective view of the biometric-authentication-apparatus-attached touchpad. FIG. 4 is a schematic cross-sectional diagram taken along the line A-A′ of FIG. 3. FIG. 5 is a schematic exploded perspective view of a transparent input sheet that constitutes a part of the biometric-authentication-apparatus-attached touchpad. FIG. 6 is a schematic cross-sectional diagram taken along the line B-B′ of FIG. 5. It should be noted that in the figures, for brevity of descriptions on the figures, a scale reduction degree is changed depending on the structure as appropriate.

In descriptions below, for convenience, directions regarding front and back, top and bottom, and left and right are directions seen from a user using the PC. Therefore, the user side will be regarded as a front side.

As shown in FIGS. 1 and 2, a PC 1 includes a display 2 and an apparatus main body 3.

The display 2 is rotatably supported by the apparatus main body 3 and includes a horizontally-long flat display casing 4 that is almost rectangular and a display panel 5 attached to the display casing 4.

The apparatus main body 3 has a structure in which requisite components are provided both inside and outside a casing 6. A keyboard 7 including a plurality of operation keys is provided on the apparatus main body 3. A front end portion of an upper surface of the apparatus main body 3 is provided as a palm rest 3a on which a user places his/her hand.

The PC 1 is equipped with, for example, a biometric-authentication-apparatus-attached touchpad 10 in the vicinity of a center portion of the palm rest 3a.

In the PC 1, a transparent input sheet 20, a click button 80, a switch button 50, and a near-infrared light window 40 of the biometric-authentication-apparatus-attached touchpad 10 are exposed.

When performing a biometric authentication using the biometric-authentication-apparatus-attached touchpad 10, a finger 200 is placed near the switch button 50 of the biometric-authentication-apparatus-attached touchpad 10 as shown in FIG. 2. At a time of photographing a finger and performing a biometric authentication, the finger 200 is placed sideways so that a nail-side surface 200a is on the near-infrared light window 40 side and a ventral-side surface 200b is on the transparent input sheet 20 side. Near-infrared light is emitted toward the finger 200 from a near-infrared light LED incorporated into the biometric-authentication-apparatus-attached touchpad 10 and scattered inside the finger 200 so that a vein pattern becomes photographable. Then, a vein pattern of the finger 200 of the user is photographed from the ventral-side surface 200b using a photographic camera incorporated into the biometric-authentication-apparatus-attached touchpad 10. In the biometric-authentication-apparatus-attached touchpad 10, photographing of a vein pattern as a verification target at a time of an authentication operation and recording of data of the vein pattern are carried out. In addition, during the authentication operation, verification of feature points between a photographed vein pattern and a vein pattern registered in advance as the verification target is carried out.

As shown in FIGS. 3 and 4, the biometric-authentication-apparatus-attached touchpad 10 includes the transparent input sheet 20, a transparent input sheet circuit board 150, a smoke board 30, the near-infrared light window 40, the switch button 50, an LED (Light-Emitting Diode) substrate 60, a casing 70, the click button 80, a click button touchpad 90, a main substrate 100, a camera-mounting substrate 110, a camera holder 120, an LED 140, and a near-infrared light transmission filter 130.

The transparent input sheet 20 is a static input device. In the transparent input sheet 20, one of main surface sides 20a exposed when incorporated into the PC 1 becomes an input operation surface. In the static transparent input sheet 20, by detecting a portion at which a capacitance has changed locally, a position on the input operation surface 20a of the transparent input sheet 20 that an object such as a finger of a user has touched and a change of that position can be detected. It should be noted that though this embodiment has exemplified a static transparent input device, the present invention is not limited thereto, and a pressure sensitive transparent input device, an optical transparent input device, an electromagnetic induction transparent input device, or the like may be used instead.

As shown in FIGS. 5 and 6, the transparent input sheet 20 is structured by sequentially laminating an X electrode substrate 22, a Y electrode substrate 23, and a ground substrate 24. The X electrode substrate 22 is formed by printing, on a transparent polyimide substrate 221 capable of transmitting near-infrared light, a striped X transparent electrode pattern 222 for detection, that is formed of ITO (Indium Tin Oxide) and extends in an X-axis direction in FIG. 5. The Y electrode substrate 23 is formed by printing, on a transparent polyimide substrate 231 capable of transmitting near-infrared light, a striped Y transparent electrode pattern 232 for detection, that is formed of ITO and extends in a Y-axis direction in FIG. 5. The ground substrate 24 is formed by printing a solid ground electrode 242 formed of ITO on an entire surface of a transparent polyimide substrate 241 capable of transmitting near-infrared light. As described above, the transparent input sheet 20 has a structure in which the detection electrode patterns are arranged in the mutually-orthogonal directions. The X electrode substrate 22, the Y electrode substrate 23, and the ground substrate 24 each include, on one side of a rectangle, a protrusion on which wirings electrically connected to the input sheet circuit board 150 are provided. The wirings provided on each of the protrusions are connected to electrodes provided on the same substrate. The protrusions of the substrates are positioned such that, when the three substrates are laminated, the protrusions are on the same side but do not overlap one another within a plane. By adopting the transparent input sheet as the input device, it is possible to transmit near-infrared light and enable a finger to be photographed by a photographic camera 111 to be described later via the transparent input sheet.

The input sheet circuit board 150 is provided with, on a substrate 153, an arithmetic circuit 152, connectors 151, and wirings (not shown) for electrically connecting the arithmetic circuit 152 and the connectors 151. The three connectors 151 are electrically connected to the X transparent electrode pattern 222, the Y transparent electrode pattern 232, and the ground electrode 242 of the transparent input sheet 20, respectively.

The transparent input sheet 20 and the input sheet circuit board 150 constitute a detection mechanism. Detection outputs of the X transparent electrode pattern 222, the Y transparent electrode pattern 232, and the ground electrode 242 are input to the arithmetic circuit 152 via the respective connectors 151, and a position within a biaxial space, that is, XY coordinates are specified. A predetermined voltage is applied to the X transparent electrode pattern 222 and the Y transparent electrode pattern 232, and a charge is thus formed between the X transparent electrode pattern 222 and the Y transparent electrode pattern 232. Due to a change in the charge caused by a touch of a finger, currents flowing through the X and Y transparent electrodes change.

By detecting this change, the XY coordinates can be specified and a position of a finger can be detected. It should be noted that the structure of the transparent input sheet such as an order in which the electrode substrates are laminated, a configuration of the electrode patterns, a layer structure of the electrode substrates, and a detection method is not limited to that described above.

As shown in FIGS. 3 and 4, the rectangular smoke board 30 is provided adjacent to the transparent input sheet 20 on the other main surface side 20b of the transparent input sheet 20 opposed to the input operation surface 20a. The smoke board 30 is interposed between the transparent input sheet 20 and the photographic camera 111 to be described later and used as a blindfold board for preventing the inside of the casing 70 from being seen by the user, thus leading to an enhancement in design. For the smoke board 30, a material capable of transmitting at least near-infrared light can be used. The smoke board 30 may be black or designed to be of the same color as the casing 6 for integrity, for example, though not limited thereto. In this embodiment, a notched portion 31 that is notched in a predetermined shape is provided at a part of the smoke board 30. Although the notched portion 31 is circular in this embodiment, the shape of the notched portion 31 is not limited thereto, and other predetermined shapes may be used instead.

The LED 140 as a second light source is positioned below the notched portion 31 of the smoke board 30 and fixed to the casing 70. The LED 140 irradiates white light toward the notched portion 31 when the biometric authentication apparatus is operated. Accordingly, a predetermined shape is projected in white at the part of the transparent input sheet 20 so that the user can recognize that a biometric authentication is being performed. As described above, the notched portion 31 of the smoke board 30 can be used as a function key. Moreover, lighting of the LED 140 may be stopped at a time the photographing of the finger by the photographic camera 111 to be described later is ended or at a time the biometric authentication is ended. When the predetermined shape on the transparent input sheet 20 disappears, the user can recognize that the photographing or the biometric authentication has ended.

The LED substrate 60 has a structure in which four near-infrared light LEDs 62 as a first light source for irradiating near-infrared light are arranged on a substrate 61, for example. The near-infrared light LEDs 62 irradiate near-infrared light onto the finger 200 for photographing a vein pattern of the finger. The substrate 61 includes a protrusion 63, and a tip end portion of the protrusion 63 is electrically connected to the main substrate 100. Wirings are provided on the substrate 61, and the near-infrared light LEDs 62 and an IC (Integrated Circuit) 101 on the main substrate 100 are electrically connected via the wirings. The finger 200 onto which the near-infrared light emitted from the near-infrared light LEDs 62 has been irradiated is photographed by the photographic camera 111 to be described later via the transparent input sheet 20.

The rectangular near-infrared light window 40 is constituted of a substrate that transmits only near-infrared light and is provided between the LED substrate 60 and an object to be authenticated placed on the switch button 50. A length of the near-infrared light window 40 in the Y-axis direction is almost the same as that of the transparent input sheet 20 in the Y-axis direction. Light emitted from the near-infrared light LEDs 62 is transmitted through the near-infrared light window 40 and irradiated onto the finger 200. By the near-infrared light window 40, the LED substrate 60 is accommodated without being exposed.

When incorporated into the PC 1, a to-be-authenticated-object placement portion 51 as an exposed portion of the switch button 50 is interposed between the near-infrared light window 40 and the transparent input sheet 20 as seen from above, and provided in the vicinity of the transparent input sheet 20. In this embodiment, the switch button 50 is a to-be-authenticated-object placement table that indicates a position at which a finger is to be placed and on which the finger is placed when photographing the finger as the object to be authenticated, and also functions as a switch to start the photographing of a finger or the biometric authentication. It should be noted that as the switch, a tact switch, a capacitance switch, and the like can be used.

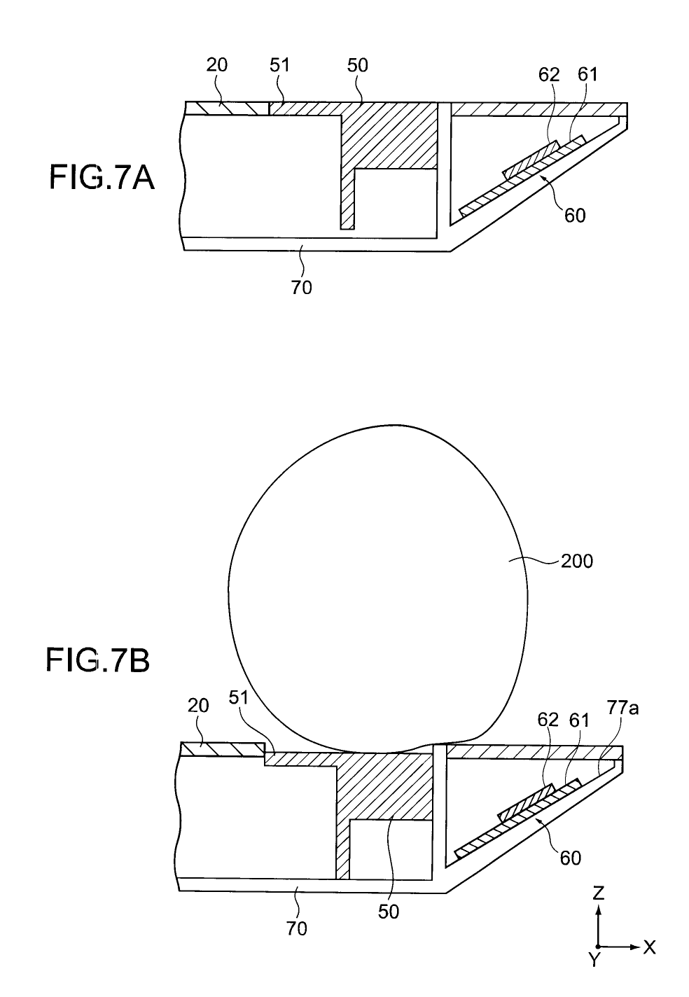

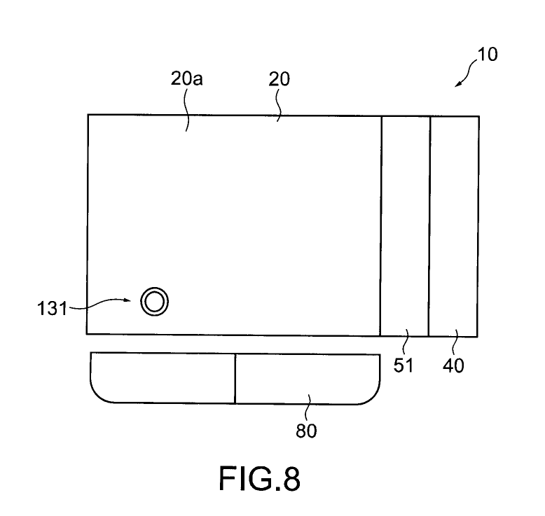

FIG. 7 are partially-enlarged diagrams of the biometric-authentication-apparatus-attached touchpad 10. FIG. 8 is a plan view of the biometric-authentication-apparatus-attached touchpad 10 during the photographing or the biometric authentication.

As shown in FIG. 7A, when the biometric authentication apparatus is unoperated, a surface of the to-be-authenticated-object placement portion 51 of the switch button 50 is on the same plane as surfaces of the transparent input sheet 20 and the near-infrared light window 40.

When the finger 200 is placed on the to-be-authenticated-object placement portion 51 of the switch button 50 and the switch button 50 is thus pressed by the finger 200 as shown in FIG. 7B, an operation made to the to-be-authenticated-object placement portion 51 is detected and photographing by the photographic camera 111 and an operation of the biometric authentication apparatus are started. Specifically, the near-infrared light LEDs 62 that irradiate near-infrared light onto the finger 200 are lit, and photographing by the photographic camera 111 to be described later is started. In addition, in this embodiment, the LED 140 is also lit, and a predetermined shape is projected in white at the part of the transparent input sheet 20 during the photographing and the biometric authentication as shown in FIG. 8. As described above, in this embodiment, the press of the switch button 50, the lighting of the near-infrared light LEDs 62 and the LED 140, and the start of the photographing by the photographic camera 111 are carried out in an interlocking manner.

The casing 70 accommodates and holds the transparent input sheet 20, the smoke board 30, the LED substrate 60, the photographic camera 111, the switch button 50, and the near-infrared light window 40. The casing 70 is substantially rectangular in a plane (XY plane). As shown in FIG. 4, the casing 70 includes a first area 75 where the transparent input sheet 20 is provided, a second area 76 where the exposed portion 51 of the switch button 50 is provided, and a third area 77 where the LED substrate 60 is provided that are obtained by dividing the casing 70 along the X-axis direction.

In the first area 75 of the casing 70, a first wall 79 is provided along a part of an outer circumference of the casing 70, and the transparent input sheet 20 is positioned within the XY plane by the first wall 79. The first wall 79 is not provided at a position corresponding to a portion at which the protrusion of the transparent input sheet 20 is formed. Moreover, in the first area 75 of the casing 70, a second wall 71 lower than the first wall 79 is provided on an inner side of the first wall 79, and the second wall 71 holds a part of a circumferential edge portion of the transparent input sheet 20.

In a first concave portion 72 surrounded by the second wall 71, the smoke board 30 is provided and held. By the second wall 71, the smoke board 30 is positioned within the XY plane.

The first concave portion 72 is additionally provided with a second concave portion 73 in which the photographic camera 111 is provided. A shape of an opening of the second concave portion 73 within the XY plane is a trapezoid whose width becomes smaller along the X-axis direction as a distance from the near-infrared light LEDs 62 increases. The second concave portion 73 includes a bottom surface 73a and a side surface 73b on which the photographic camera 111 is provided, and an attachment hole 73c penetrating the casing 70 in a Z-axis direction is formed on the bottom surface 73a.

The bottom surface 73a has an angularity such that a depth (Z-axis direction) of the concave portion increases as a distance from the near-infrared light LEDs 62 increases, and formed such that the width becomes smaller along the X-axis direction as the distance from the near-infrared light LEDs 62 increases. Due to the second concave portion 73 having such a shape, the casing 70 does not block a photographic space at a time the finger 200 is photographed by the photographic camera 111. Further, the bottom surface 73a is structured to have almost the same thickness. Therefore, a space 171 is formed below the second concave portion 73, with the result that the main substrate 100 and the like can be accommodated in the space 171 and the entire biometric-authentication-apparatus-attached touchpad 10 can therefore be miniaturized.

The side surface 73b is positioned in correspondence with an upper side of the trapezoid as the shape of the opening of the second concave portion 73 and has an angularity for obliquely disposing the photographic camera 111 with respect to the finger 200 so that the finger 200 can be photographed with ease.

The attachment hole 73c is a hole for inserting the camera-mounting substrate 110 on which the photographic camera 111 is mounted from a lower (back surface) side of the casing 70.

The notched portion 31 of the smoke board 30 and the LED 140 are provided in a fourth area 78 unaffected by the photographing of the finger 200, that is an area within the first area 75 of the casing 70 other than the photographic area between the photographic camera 111 and the finger 200. With this structure, the authentication can be performed accurately without being influenced by the light from the LED 140 during the photographing. It should be noted that the LED 140 is provided in a fourth concave portion 173 that is provided in an area corresponding to a notched portion of the first concave portion 72.

As shown in FIG. 4, in the fourth area 78, although a concave portion exists when the casing 70 is seen from the lower (back surface) side, a drive circuit board (not shown) is provided in this concave portion.

At a part of the second area 76 of the casing 70 and the first area 75 adjacent to the second area 76, a third concave portion 172 in which the switch button 50 is provided is formed.

In the third area 77 of the casing 70, a slope 77a on which the LED substrate 60 is disposed and held inside the casing 70 is formed. The slope 77a has an angularity so that near-infrared light from the near-infrared light LEDs 62 is efficiently irradiated onto the finger 200. The second area 76 and the third area 77 are separated by a wall so that the light from the near-infrared light LEDs 62 does not enter the second area 76.

The camera-mounting substrate 110 is constituted of a flexible substrate 112 including a camera-mounting portion 113 and the photographic camera 111 fixed to the camera-mounting portion 113. The camera-mounting portion 113 of the camera-mounting substrate 110 is attached to the side surface 73b of the casing 70 via the attachment hole 73c from the lower (back surface) side of the casing 70. A substrate portion other than the camera-mounting portion 113 of the camera-mounting substrate 110 is bent, and an end portion thereof is electrically connected to the main substrate 100 provide inside the space 171.

The camera holder 120 is provided on the lower (back surface) side of the casing 70 and fixedly holds the camera-mounting substrate 110 and the casing 70.

The near-infrared light transmission filter 130 is a filter that is provided between the finger 200 and the photographic camera 111, specifically, in front of the photographic camera 111 in this embodiment, and transmits only near-infrared light. The finger 200 is photographed by the photographic camera 111 via the near-infrared light transmission filter 130. With this structure, a vein pattern of the object to be authenticated can be photographed clearly. It should be noted that when a material that transmits only near-infrared light is used for the smoke board 30, the near-infrared light transmission filter 130 can be omitted. Moreover, by extending the near-infrared light window 40 so that it is positioned on the other main surface side 20b of the transparent input sheet 20, the near-infrared light window 40 may also function as a smoke board, with the result that the number of components can be reduced. A board that transmits only near-infrared light is generally expensive. Therefore, by providing the near-infrared light transmission filter that transmits only near-infrared light only in front of the photographic camera 111 as in this embodiment, an area of the near-infrared light transmission filter can be reduced and costs can therefore be cut.

The click button 80 includes a right-hand click button and a left-hand click button. The click button touchpad 90 is provided below the click button 80. By the user pressing the right-hand click button and the left-hand click button downward with a finger or the like, an input is recognized by the click button touchpad 90.

The IC 101 is mounted on the main substrate 100. Incorporated into the IC 101 are an authentication circuit for a biometric authentication as means for authenticating the object to be authenticated based on an image taken by the photographic camera 111, and a memory for recording biometric authentication data (vein pattern). The main substrate 100 is electrically connected to the LED substrate 60, the camera-mounting substrate 110, and the LED 140. Moreover, when photographing a vein pattern as a verification target during the authentication operation, by pressing the to-be-authenticated-object placement portion 51 of the switch button 50, an operation to the to-be-authenticated-object placement portion 51 is detected. The IC 101 performs control so that, by the press of the switch button 50, the near-infrared light LEDs 62 and the LED 140 are lit and photographing by the photographic camera 111 is started. Then, when the photographing is ended, the IC 101 performs control so that the lighting of the near-infrared light LEDs 62 and the LED 140 is stopped. Due to the stop of the lighting of the LED 140, the user of the PC 1 can recognize the end of the photographing. After the photographing is ended, data of the photographed vein pattern is recorded. Moreover, when the to-be-authenticated-object placement portion 51 of the switch button 50 is pressed during the authentication operation, the IC 101 performs control so that the near-infrared light LEDs 62 and the LED 140 are lit and the photographing by the photographic camera 111 is started. Then, when the photographing is ended, the IC 101 performs control so that the lighting of the near-infrared light LEDs 62 and the LED 140 is stopped. Due to the stop of the lighting of the LED 140, the user of the PC 1 can recognize the end of the photographing. After the photographing is ended, the IC 101 performs an authentication by verifying feature points of the photographed vein pattern and a vein pattern registered in advance as the verification target. It should be noted that although the lighting of the LED 140 has been stopped at the time the photographing is ended in this case, it is also possible for the lighting of the LED 140 to be stopped at a time the authentication operation is ended so that the user can recognize the end of the authentication by the stop of the lighting of the LED 140.

In the above embodiment, the photographing and the biometric authentication have been started by the switch button 50. However, the present invention is not limited thereto, and it is also possible to adopt, for example, a capacitance-type button so that photographing and a biometric authentication are started when a finger touches a specific area of the transparent input sheet.

In the above embodiment, the switch button 50 has been provided on the right-hand side of the transparent input sheet 20. However, it is of course possible to provide the switch button on the left-hand side of the transparent input sheet. In this case, the near-infrared light LEDs are arranged on the left-hand side of the switch button.

The above embodiment has described the case where the biometric-authentication-apparatus-attached touchpad is applied to the PC. However, the biometric-authentication-apparatus-attached touchpad is also applicable to other information processing apparatuses such as an AMT of banks, a mobile information terminal, a cellular phone, and a smart phone. Moreover, in the above embodiment, the display panel and the touchpad have been provided separately. However, it is possible to provide a biometric-authentication-apparatus-attached touchpad such that the transparent input sheet is positioned on the display panel and use it in place of the switch button 50.

Further, while the user of the PC can be authenticated by providing the biometric-authentication-apparatus-attached touchpad to the PC in this embodiment, the biometric-authentication-apparatus-attached touchpad can also be used for photographing an object to be authenticated for identity verification in net banking. In this case, an authentication function does not need to be provided to the biometric-authentication-apparatus-attached touchpad and only a photographic function needs to be provided, that is, the touchpad may be a photographic-apparatus-attached touchpad.

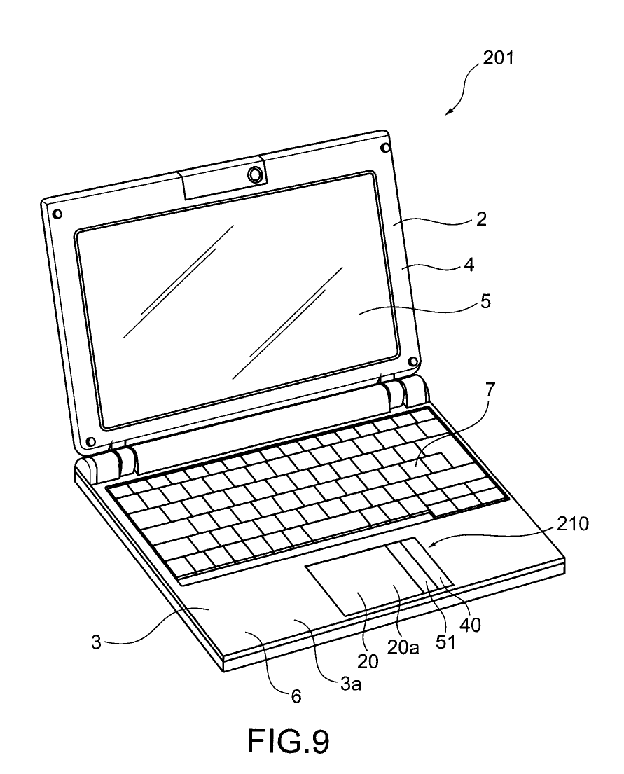

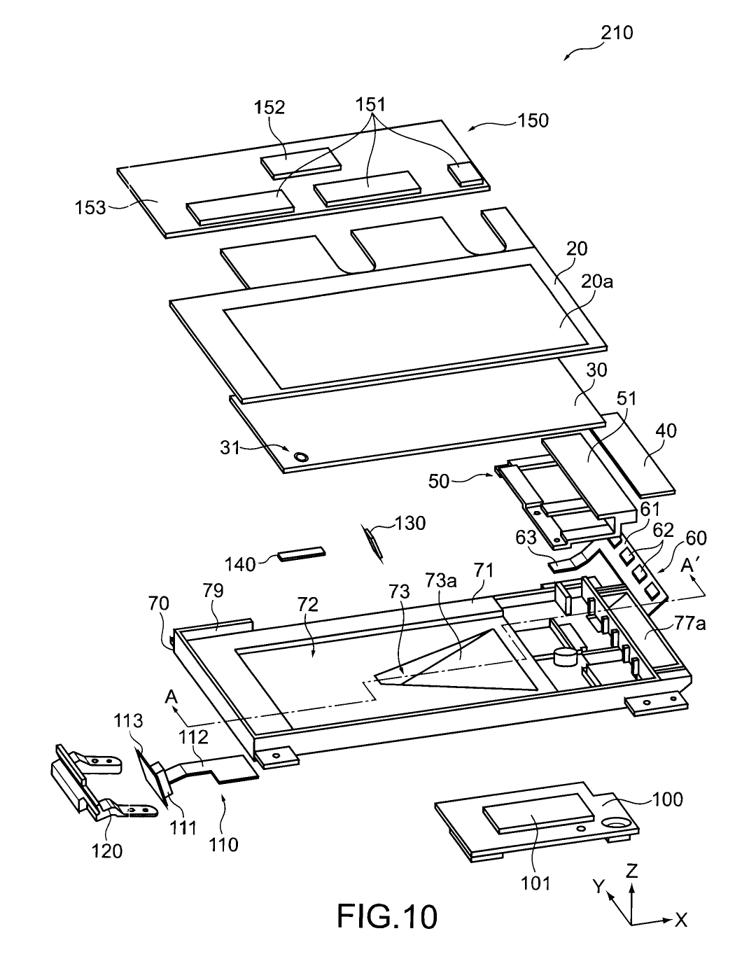

Moreover, although a click button is provided to the biometric-authentication-apparatus-attached touchpad in the above embodiment, a biometric-authentication-apparatus-attached touchpad 210 without a click button may be provided as shown in FIGS. 9 and 10. FIG. 9 is a perspective view of a PC 201 into which the biometric-authentication-apparatus-attached touchpad 210 is incorporated. FIG. 10 is an exploded perspective view of the biometric-authentication-apparatus-attached touchpad 210. It should be noted that structures that are the same as those of the above embodiment are denoted by the same symbols. In such a structure in which a click button is not provided, it is possible to provide the transparent input sheet 20 and the to-be-authenticated-object placement portion 51 adjacent thereto closer to the front end of the apparatus main body 3. Therefore, a middle finger, a ring finger, and a pinky can be located outside the PC 201 at a time an index finger of a right hand is placed on the to-be-authenticated-object placement portion 51 as an object to be authenticated, for example, with the result that it becomes easier to place the index finger to thus improve an operability.

Furthermore, although the to-be-authenticated-object placement portion on which a finger is placed has been provided on the right-hand side of the touchpad in the above embodiments, the to-be-authenticated-object placement portion may be provided on any of the left-hand side, the front side, or the rear side of the touchpad. For example, when registering a finger of a left hand as the object to be authenticated, an operability is improved when providing the to-be-authenticated-object placement portion on the left-hand side of the touchpad.

As described above, in the above embodiments, by providing the photographic camera on the main surface side of the transparent input sheet of the touchpad opposed to the input operation surface 20a (lower side of transparent input sheet) and providing the near-infrared light LEDs, the touchpad and the biometric authentication apparatus (or photographic apparatus) can be integrated. Accordingly, an installation area can be made smaller than that in a case where the touchpad and the biometric authentication apparatus (or photographic apparatus) are provided separately, with the result that the information processing apparatus into which the biometric authentication apparatus (or photographic apparatus) is incorporated can be miniaturized.

The present application contains subject matter related to that disclosed in Japanese Priority Patent Application JP 2009-029414 filed in the Japan Patent Office on Feb. 12, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
a detection mechanism that includes a transparent substrate on which a detection electrode pattern is provided in biaxial directions and detects, with one of main surface sides of the transparent substrate being an input operation surface, a position on the input operation surface within the biaxial space that an object has touched, the transparent substrate being capable of transmitting near-infrared light;
a to-be-authenticated-object placement portion that is provided in the vicinity of the input operation surface of the detection mechanism and on which the object is placed as an object to be authenticated;
a first light source to irradiate the near-infrared light onto the object to be authenticated placed on the to-be-authenticated-object placement portion; and
a photographic camera that is provided on the other one of the main surface sides of the transparent substrate of the detection mechanism and photographs the object to be authenticated onto which the near-infrared light has been irradiated via the transparent substrate.

2. The information processing apparatus according to claim 1, further comprising
means for authenticating the object to be authenticated based on an image taken by the photographic camera.

3. The information processing apparatus according to claim 2, further comprising
a casing to hold the detection mechanism, the first light source, and the photographic camera.

4. The information processing apparatus according to claim 3,
wherein lighting of the first light source is started when an operation to the to-be-authenticated-object placement portion is detected.

5. The information processing apparatus according to claim 4, further comprising
a blindfold board that is provided adjacent to the detection mechanism between the detection mechanism and the photographic camera and transmits at least the near-infrared light.

6. The information processing apparatus according to claim 5, further comprising
a filter that is provided between the object to be authenticated and the photographic camera and transmits only the near-infrared light.

7. The information processing apparatus according to claim 6,
wherein the blindfold board includes a notched portion of a predetermined shape in an area other than an area corresponding to a photographic space between the photographic camera and the object to be authenticated,
the information processing apparatus further comprising
a second light source to irradiate light onto the notched portion.

8. The information processing apparatus according to claim 7,
wherein lighting of the second light source is started when an operation to the to-be-authenticated-object placement portion is detected.

9. The information processing apparatus according to claim 8, further comprising
a near-infrared light window that is provided between the object to be authenticated and the first light source and transmits the near-infrared light.
